(19) United States
(12) Patent Application Publication
(10) Pub. No.: US 2010/0159293 A1
(43) Pub. Date: Jun. 24, 2010

(54) DEVICE FOR PRODUCING ELECTRICAL ENERGY AND A CHARGING CURRENT SIGNAL, AND A DEVICE FOR PRODUCING ELECTRICAL ENERGY CHARGED BY THE CHARGING CURRENT SIGNAL

(75) Inventor: Jorg Raimund Hempel, Bad Urach (DE)

Correspondence Address: Perman & Green, LLP, 99 Hawley Lane, Stratford, CT, 06614, US

(73) Assignee: IMP GmbH, Munchen (DE)

(21) Appl. No.: 12/489,584

(22) Filed: Jun. 23, 2009

(30) Foreign Application Priority Data
Jun. 24, 2008 (DE) 10 2008 029 806.9
Mar. 11, 2009 (DE) 10 2009 012 529.9

(51) Int. Cl. H01M 2/00; H02J 7/00

(52) U.S. Cl. 429/10; 320/166; 320/167

(57) ABSTRACT

A device for producing electrical energy having at least one ion cell can produce a magnetic field at the location of the at least one ion cell and also has at least one capacitance or an interconnection of at least two electrically connected capacitances, of which two contacts of counter pole electrodes are connected to the counter pole electrodes of the at least one ion cell, and a consumer load may be connected in parallel to the capacitance and the interconnection of capacitances, respectively.

### BACKGROUND

1. Field

The disclosed embodiments relate to a device for producing electrical energy, as well as to a novel charging current signal and a device for producing electrical energy charged by the charging current signal.

2. Brief Description of Related Developments

It is known to use ion cells in electrochemical current sources. An ion cell or several ion cells (also called galvanic cells) connected in series are referred to as a battery. Ion cells convert the chemical energy stored in them directly into electrical energy. The reaction supplying the energy, the discharge, is composed of two partial reactions (electrode reactions) which are spatially separated but coupled to each other. The electrode in which the corresponding partial reaction takes place at a lower redox potential in comparison to the other electrode is the negative electrode (−), the other one is the positive electrode (+). During the discharge of the ion cell an oxidation process occurs at the negative electrode by which electrodes are released; in parallel thereto a corresponding amount of electrodes is collected at the positive electrode via a reduction process. The electrode current flows from (−) to (₊) through an external consumer load circuit. Inside the ion cell, the current is carried by ions between the electrodes in an ionically conducting electrolyte (ion current), with ion and electron reactions being coupled to each other in/at the electrode.

A difference is made between primary cells that use themselves up during their discharge, and rechargeable cells, which are also called accumulators, in which the electrochemical discharge reactions can be reversed to a large extent so that a multiple conversion from chemical into electrical energy and back may take place. During these discharging/charging cycles alternate oxidation and reduction processes are performed at each electrode so that one must be careful when using the designation anode or cathode, which are defined by the terms of oxidation or reduction. This problem can be avoided by using the terms of negative electrode or positive electrode because the respective electrode potential in a normal charging/discharging operation always remains more negative or positive than that of the other electrode. In parallel thereto, however, there is the convention that the electrodes are named in accordance with their function during the discharge, that is, the negative electrode is referred to as the anode and the positive electrode is referred to as the cathode.

Generally, an ion cell in a battery or an accumulator consists of one electrolyte, two electrodes arranged together in a battery casing, which may include a plurality of ion cells, and separators that are permeable to ions but impermeable to electrons and with which it is possible to avoid a short circuit due to internal electrode contact. The so-called active materials are the actual storages of the chemical energy in the battery or the accumulator. The electrical energy is released during the discharge due to its electrochemical turnover at the electrodes. The number of electrodes released or collected in this process per unit of mass or volume determines the storage capacity of the active electrode material and is indicated as the specific load (in Ah kg⁻¹) and charge density (in Ah cm⁻³), respectively.

Widely used accumulators of this kind are lithium ion accumulators which are particularly used in portable devices of high energy demand, such as, for example, in mobile phones, digital cameras, camcorders, laptops or the like, as well as in electric and hybrid vehicles. At present, they are also increasingly used in electric tools, such as cordless screwdrivers, for example, due to their high charge density.

In an accumulator electrical energy is converted into chemical energy during the charging. If a consumer load is connected, the chemical energy is converted back into electrical energy. Furthermore, when accumulators are charged and discharged, heat is released by which a part of the energy used for charging is lost. In conventional accumulators, the charging efficiency, that is, the ratio of the withdrawable energy to the energy to be used for charging, is normally about 60 to 95 percent.

Usually, optimal charging of different types of accumulators is effected with not-too-high charging currents over a comparatively long period of time. A 20-hour charging of a lead accumulator used as a car battery, for example, is to be given preference over a fast charging within a few hours with higher charging currents because the latter may reduce the efficiency and the service life of the lead accumulator.

### SUMMARY

It is the object of the disclosed embodiments to improve the efficiency of devices for producing electrical energy with ion cells as well as to provide a novel charging current signal and a device for producing electrical energy with which the charging efficiency of galvanic cells and electrolyte capacitors is considerably enhanced and the charging time may be substantially reduced.

This object is achieved by means of devices for producing electrical energy according to claims 1, 20, 21, 24, and 28.

Features of preferred aspects of the disclosed embodiments are characterized in the subclaims.

According to one aspect of the disclosed embodiments, the device comprises: at least one ion cell, means for producing a magnetic field at the location of the at least one ion cell and at least one capacitance or an interconnection of at least two capacitances, of which two contacts of counter pole electrodes are connected to the counter pole electrodes of the at least one ion cell, and a consumer load may be connected in parallel to the capacitance or the interconnection of capacitances.

In a first series of experiments with aspects of the disclosed embodiments an energy output of the device which cannot be explained by the state of knowledge of current research regarding the duration as well as the performance was observed and measured.

Furthermore, the aspects of the disclosed embodiments are based on the observation that the application of a magnetic field to an ion cell, in particular a lithium ion cell, leads to the fact that the current withdrawn from this cell has properties which cannot merely be characterized by the current intensity.

It was found that the current produced in this manner is particularly suitable for charge separation in galvanic cells, that is, in other words, for charging galvanic cells or for charging electrolytic capacitors. As the current thus produced effects a charge separation in a galvanic cell or an electrolytic capacitor, as will be explained below in more detail by means of a description of an experiment, which charge separation is not correlated to the amount of the supply of electrical energy following current physical findings, this charging current will be referred to in the following as charging current signal. A galvanic cell upon which such a charging current signal acts shows a charging behavior which is optimized as to charging time and charging current to be provided.

### BRIEF DESCRIPTION OF THE DRAWINGS

Below, the aspects of the disclosed embodiments will be explained in more detail by means of the description of embodiments and experiments with reference to the drawings, wherein:

FIG. 1 is a circuit diagram of a first embodiment of the present invention;

FIG. 2a is a second embodiment of the present invention;

FIG. 2b is a variant of the embodiment shown in FIG. 2a;

FIG. 3 is a perspective exploded view of an array of permanent magnet strips on a series connection of ion cells; and

FIG. 4 is another embodiment of the present invention.

### DETAILED DESCRIPTION OF THE DISCLOSED EMBODIMENTS

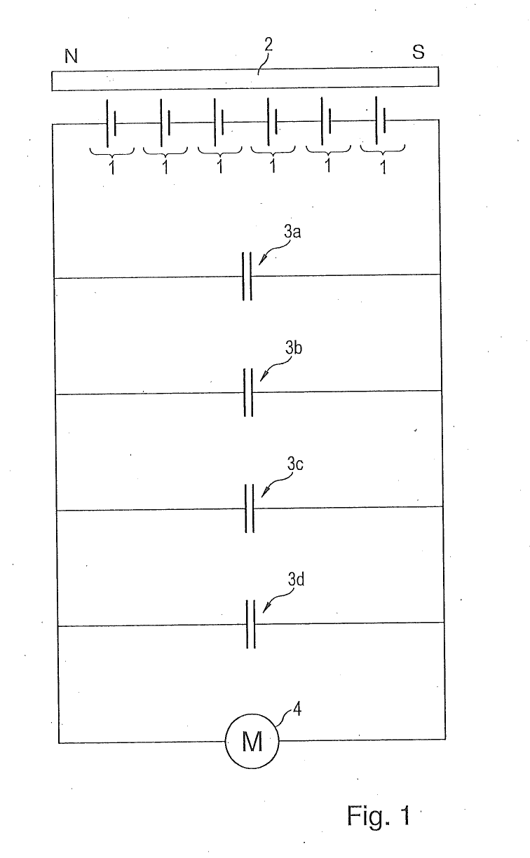

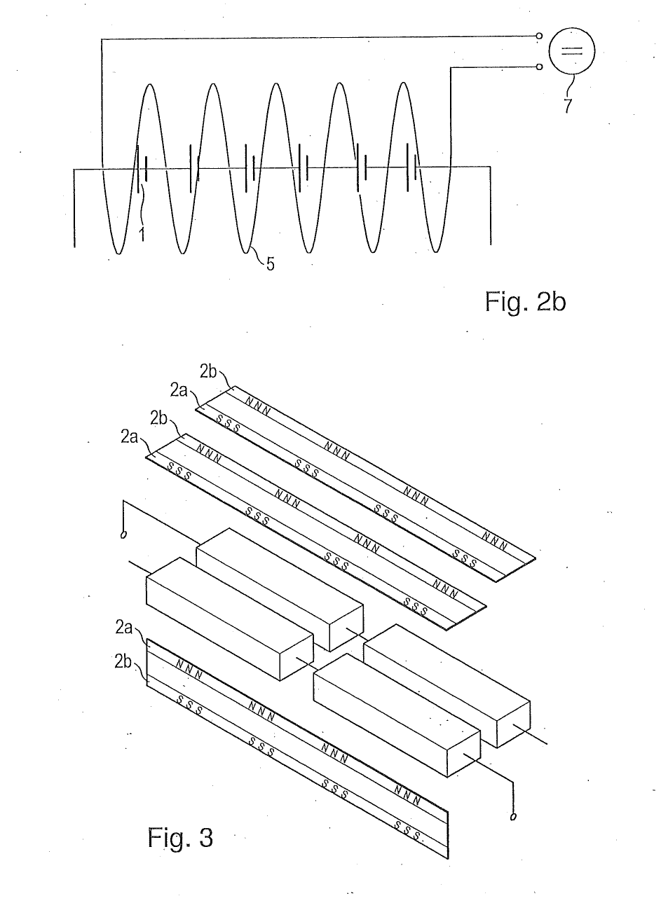

FIG. 1 shows one embodiment of a device for producing electrical energy. In this embodiment six ion cells 1 are connected in series. A permanent magnet 2 is mounted as closely as possible, for example, to the casing walls of the ion cells 1 so that all ion cells 1 are permeated by the magnetic field produced by the permanent magnet 2. An embodiment of the attachment of permanent magnets is shown in FIG. 3, as described further below.

A capacitor bank consisting of four capacitors 3a to 3d connected in parallel and a load 4 are connected to the series connection of the ion cells 1. As has been found, the four capacitors connected in parallel together can be charged faster than a corresponding capacitor of the same capacity as the sum of the capacities of the capacitors connected in parallel.

In the following, a first experiment will be described which was carried out with the following means:

The accumulators were each liberated of associated electronics by which a deep-discharge is to be avoided. These were commercially available lithium ion accumulators having a nominal capacity of 750 mAh as are used, for example, in mobile phones or laptops. Six lithium ion accumulators were connected in series and deep-discharged. The deep-discharge was at first made by coupling a consumer load in order to achieve a slow discharge and at the end the series connection was short-circuited. A measurement of the voltage showed that no voltage could be measured at the accumulator series connection. The capacitors used during the experiment were electrolyte capacitors connected in parallel to form a capacitor bank. In this case the capacitor bank was also at first short-circuited to ensure that there is no charge in the capacitors. Subsequently, the ion cell battery was provided with permanent magnets, as shown in FIG. 3. Here, they are commercially available magnetic strips of a width of about 1 cm, on the outer edges of which a magnetized substance had been attached in parallel to the longitudinal extension of the strips. The polarities of the magnets running parallel to each other were opposed.

The battery unit combined into a block of accumulators arranged in parallel to each other was surrounded by the magnetic strips.

Next, the deep-discharged lithium ion accumulator series connection was connected to the corresponding poles of the capacitor bank.

Completely surprisingly and unexpectedly, a voltage of 23.8 V built up between the poles of the accumulator series connection after about 10 s. After separating the capacitor bank from the accumulator array and short-circuiting until the voltage level dropped to zero, a voltage of 33 V built up again contrary to expectations between the poles of the capacitor bank after about 90 s.

This is all the more astonishing since electrolytic capacitors usually have no charge remanence.

Finally, the accumulator series connection was connected to the capacitor bank 3a-3d and in turn a load 4 was connected thereto. In the experiment as carried out the load 4 consisted of a DC motor having a nominal voltage of 40 V and a no-load current of 0.8 A as well as an Iₘₐₓ of 6.3 A. In the experiment as carried out, the motor was supplied with a voltage of 12 V. The permanent current consumption resulting therefrom was 80 mA. The motor started and soon achieved a constant speed at which it ran for 144 hours in a long-time test. According to expectations, using a conventional, fully charged accumulator the motor would have had to stop after a few hours at the latest due to a lack of sufficient applied voltage; in this case, however, a deep-discharged accumulator array was used in which a voltage rise was observed and measured during the current consumption in the course of time instead of a voltage drop.

During the power consumption neither the capacitors nor the accumulator series connection heated up noticeably.

Furthermore, the following phenomena were observed in this array. The accumulator array was separated from the capacitor bank and discharged for a few seconds by short-circuiting. After connecting the capacitor bank to the accumulator array the capacitors were charged within a very short time (on the order of 0.5 s).

The capacitor bank was discharged by means of a filler wire having a cross-sectional area of 1 mm². The discharge process was very rapid, i.e. within a few milliseconds, with a high current that melted the filler wire, and a formation of sparks.

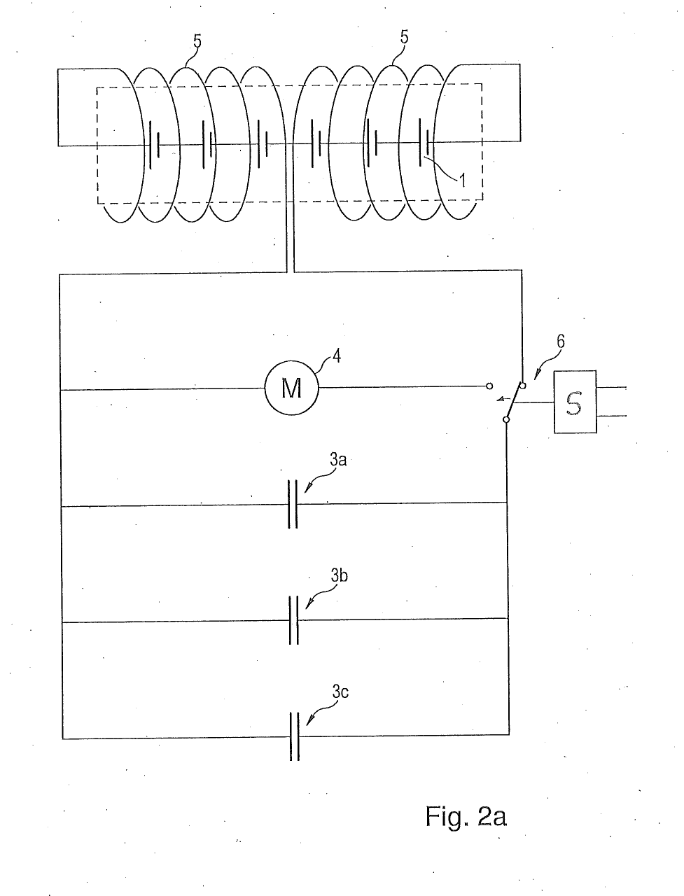

FIG. 2a shows another embodiment in which the permanent magnet 2 was replaced by a wire-wound coil. The coil 5 is wound around the accumulator series connection and connected in series to the capacitance. Thus, an electromagnet is formed and the accumulators are aligned in parallel to the axis of the electromagnet in the axial direction thereof.

FIG. 2b shows a detail of another embodiment in which the electromagnet coil 5 is fed by an external current source.

Furthermore, the embodiment shown in FIG. 2a has a change-over switch 6 by which the accumulator series connection is alternately connected to the capacitor bank 3a-3c or to the load 4. By switching the change-over switch 6 either the capacitor bank is charged by the accumulator series connection or the load 4 is fed by the capacitor bank.

The switching frequency of the change-over switch is suitably selected so that the capacitors 3a-3c are discharged by a maximum of 20 to 30%, i.e., after the discharge they still have a residual charge of 70 to 80% of their maximally storable charge. The charging of the capacitors takes place faster in this charging range than in the case when the capacitors would be discharged to a lower level per cycle.

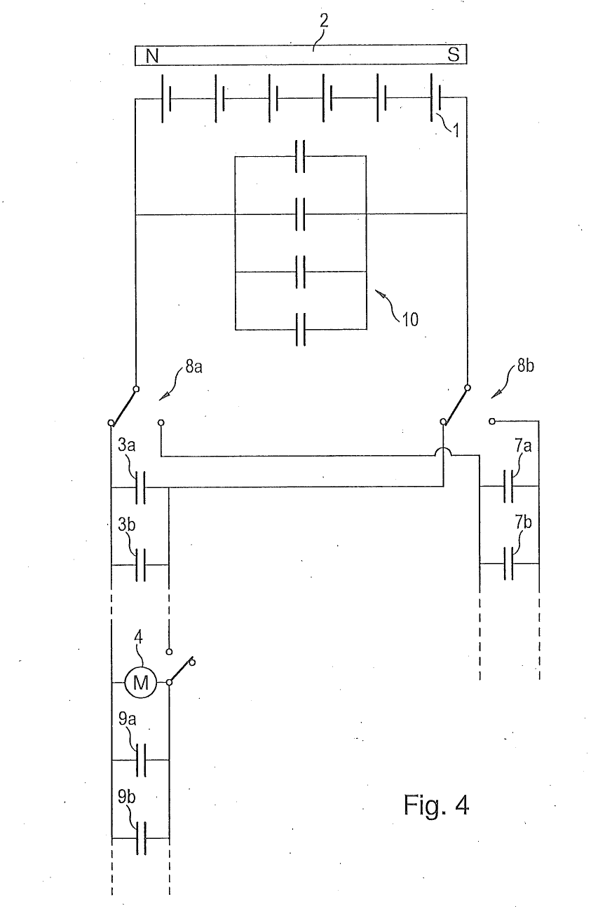

FIG. 4 shows another embodiment in which, in the case as shown, two capacitor banks 3a, 3b, . . . and 7a, 7b . . . are alternatively connected in a clocked manner to the accumulator array by the change-over switches 8a, 8b. Moreover, a capacitor bank 10 is connected in parallel to the accumulator array.

Likewise, it is conceivable to connect more than two capacitor banks in sequence to the accumulator array.

Furthermore, it should be noted that it is also possible to use non-discharged accumulators instead of deep-discharged accumulators.

Due to the device for producing electrical energy according to the aspects of the disclosed embodiments, it is possible to implement applications which open up previously unreached dimensions as regards the power output as well as the ambition to make energy sources more compact and lighter.

In the following, a second experiment will be described which was carried out with the following means:

A motorbike battery, in this case a lead accumulator having a rated voltage of 12 V and a capacitance of 12 Ah, was slowly discharged via a consumer load until the terminal voltage was only about 3 V. The discharge was made with a small discharging current so that the motorbike battery did not noticeably heat up.

Then the motorbike battery was connected for recharging to four series-connected lithium ion accumulators prepared with magnetic strips. The device for producing electrical energy using lithium ion accumulators described in the present patent application comprises an array of one or more electrolytic capacitor(s) connected in parallel to the series connection of lithium ion accumulators. Such electrolytic capacitors may be used as intermediate storages of electrical energy in the experiment described here, however, they are not compulsory.

In the experiment described here, a series connection comprising permanent magnet strips of prepared lithium ion accumulators without electrolytic capacitors connected in parallel was used.

In order to charge the motorbike battery, the above-described lithium ion accumulator array was connected to the battery. After about 20 minutes the motorbike battery was fully charged and showed a voltage of about 14 V, that is, 2 V above its rated voltage, at its terminals. The surprisingly short time until the full charge of the motorbike battery allows the conclusion that a very high charging current has flown during this time. It turned out to be difficult to measure the current directly by inserting a digital multimeter measurement apparatus into the circuit because the charging time strongly increased for unknown reasons until the motorbike battery was fully charged.

Nevertheless, in order to get an idea of the dimension of the charging current, the charging cable was cut through at one spot and the gap in the circuit was bridged by cable portions of different cross-sectional areas. The discharging and charging process, as described above, was repeated several times and the very short charging time of between 2 and 20 minutes respectively appeared again. The most astonishing fact, however, was that even when the circuit gap was bridged by a “telephone wire” having a cross-sectional area of about 0.75 mm² and a length of about 20 cm, the wire did not heat up beyond room temperature. Thus, it is certain that during the charging of the lead accumulator no current corresponding to the amount of energy which the lead accumulator regained after the recharging process flew within the short charging time. The charging current required for this purpose would have had to be so large within the short charging time that it would have made the “telephone wire” melt without fail. The wire, however, did not even heat up.

This allows the conclusion that in case of the above-described charging process electrical energy is not transferred from an electrical energy source to a galvanic storage for electrical energy, as usual, which can then be withdrawn again after subtraction of the energy converted into reaction heat, but that the charging current, referred to as charging current signal below, merely “triggers” the galvanic cell, that is, the chemical reaction which occurs in the galvanic cell is merely initiated by the charging current signal and not maintained by a corresponding addition of electrical energy.

It is a fact that the described technical effect, namely the fast chargeability of a galvanic cell with the charging current signal produced as described above and the inexplicably high charging efficiency may be reproducibly imitated in the manner as described above, as proven by the multitude of successfully performed experiments.

What is claimed is:

1. A device for producing electrical energy, comprising:
at least one ion cell,
means for producing a magnetic field at the location of the at least one ion cell and at least one capacitance or an interconnection of at least two electrically connected capacitances, of which two contacts of counter pole electrodes are connected to the counter pole electrodes of the at least one ion cell, and a consumer load can be connected in parallel to the capacitance and the interconnection of capacitances, respectively.

2. The device according to claim 1, further comprising that
the ion cell comprises positively charged ions of the metals Li, Na, Mg, Pd, Al, Zn, Cd, Pb or compounds of these metals.

3. The device according to claim 1, further comprising that
the at least one ion cell is a lithium ion accumulator.

4. The device according to claim 1, further comprising that
the ion cell is a lithium ion accumulator the positive electrode of which comprises ions of the compounds: LiCoO₂; LiNiO₂; LiNi₁₋ₓCoₓO₂; LiNi_{0.85}Co_{0.1}Al_{0.05}O₂; LiNi_{0.33}CO_{0.33}Mn_{0.33}O₂; LiMn₂O₄ spinel or LiFePO₄.

5. The device according to claim 1, further comprising that
a plurality of ion cells is connected in series.

6. The device according to claim 1, further comprising that
a plurality of ion cells is connected in parallel and/or in series.

7. The device according to claim 1, further comprising that
the means for producing a magnetic field comprise permanent magnets.

8. The device according to claim 7, further comprising that
the permanent magnets are strip-shaped and the array of the ion cells is densely covered with these magnetic strips.

9. The device according to claim 8, further comprising that
the magnetic strips are arranged in parallel to each other with alternating polarity.

10. The device according to claim 8, further comprising that
the magnetic strips run substantially in parallel to axes running through the counter pole electrodes of the at least one ion cell.

11. The device according to claim 10, further comprising that
in a plurality of ion cells the axes respectively run in parallel to each other through the counter pole electrodes thereof.

12. The device according to claim 1, further comprising that
the means for producing a magnetic field is at least one electromagnet.

13. The device according to claim 12, further comprising that
the electromagnet or the electromagnets is/are supplied with direct current by the at least one ion cell.

14. The device according to claim 12, further comprising that
the electromagnet or the electromagnets is/are supplied with direct current by an external current source.

15. The device according to claim 12, further comprising that
the electromagnet produces a static magnetic field and the ion cell(s) is (are) arranged in the magnetic field.

16. The device according to claim 1, further comprising that
a clocked change-over switch periodically interrupts the connection between the ion cell array and the interconnection of the capacitances and sets up the connection between the capacitance interconnection and a consumer load.

17. The device according to claim 16, further comprising that
the clock frequency is selected such that the capacitance or the interconnection of the capacitances discharges by 20 to 30% when the circuit to the consumer load is closed.

18. The device according to claim 1, further comprising that
the ion cell array is deep-discharged before the current source is put into operation.

19. The device according to claim 1, further comprising that
the capacitance or the capacitances is an electrolytic capacitor or are electrolytic capacitors.

20. A device for producing electrical energy comprising:
a capacitance or a capacitance bank comprising a plurality of interconnected capacitances which is/are charged by a first device according claim 1, then is/are electrically separated from this first device, and a consumer load may be connected to the capacitance or the capacitances electrically separated from the first device.

21. A device for producing electrical energy comprising:
a first device according to claim 1,
wherein at least two capacitance banks each comprising a capacitance or a plurality of interconnected capacitances are alternatingly connected in a clocked manner to the first device by a change-over switch, and are separated from the first device by a clock of the same frequency in phase opposition and may be connected to one or a plurality of consumer loads.

22. The device according to claim 21, further comprising that
a consumer load is the first device which is periodically charged in a controlled manner by a capacitor bank.

23. The device according to claim 21, further comprising that
another capacitor bank comprising at least one capacitor or a plurality of capacitors connected in parallel is connected between at least one capacitance bank and the consumer load contact.

24. The device according to claim 20, further comprising that
the capacitances are capacitors wherein
at least one of the capacitors used is an electrolytic capacitor.

25. A charging current signal for effecting a charge separation in a galvanic cell or an electrolytic capacitor, produced by a device positioned in a magnetic field, at least during a predetermined period of time, and comprising two electrodes in an electrolyte separated by a separator impermeable for electrodes.

26. A charging current signal for effecting a charge separation in a galvanic cell or an electrolytic capacitor, produced by an ion cell positioned in a magnetic field, at least during a predetermined period of time.

27. A device for producing electrical energy, comprising a galvanic cell which is alternately supplied at the electrodes thereof with a charging current signal according to claim 26 until a first predetermined voltage level is achieved or current is withdrawn therefrom by a consumer load until the voltage has dropped to a second voltage level.

28. The device according to claim 27, further comprising that the electrical energy released to the galvanic cell from the ion cell positioned in a magnetic field during a charging time t₁ is less than the energy withdrawable during the discharge cycle t₂ of the galvanic cell.

29. The device according to claim 27, further comprising that the galvanic cell consists of at least one secondary cell.

30. The device according to claim 27, further comprising that the galvanic cell is a lead accumulator, a nickel cadmium accumulator, a nickel hydrogen accumulator, a nickel metal hydride accumulator, a lithium ion accumulator, a lithium polymer accumulator, a lithium metal accumulator, a nickel iron accumulator, an SCiB, a silver zinc accumulator, a vanadium redox accumulator or a zinc chromium accumulator.

31. A device for producing electrical energy, comprising an electrolytic capacitor, a super cap or gold cap capacitor which is alternately supplied at the electrodes thereof with a charging current signal according to claim 26 until a predetermined voltage level is achieved or current is withdrawn therefrom by a consumer load until the voltage has dropped to a second voltage level.

32. The device according to claim 27, further comprising that the ion cell is a lithium ion cell.

33. The device according to claim 27, further comprising that the magnetic field is produced by permanent magnets mounted to the ion cell.

34. The device according to claim 33, wherein the permanent magnet(s) comprise(s) parallel magnetic strips of alternating polarity mounted to the casing of the ion cell.

35. A device for producing electrical energy, comprising:
at least one ion cell exposed to a magnetic field produced at the location of the ion cell for at least a predetermined period of time, and a galvanic cell which can be connected in parallel thereto.

36. The device according to claim 35, further comprising that a consumer load can be connected to the galvanic cell when the connection between the galvanic cell and the ion cell is open.

37. The device according to claim 35, further comprising that the ion cell is a lithium ion accumulator or a lithium polymer accumulator.
